(19) United States
(12) Patent Application Publication
(10) Pub. No.: US 2025/0379005 A1
(43) Pub. Date: Dec. 11, 2025

(54) ECONOMIZING CONTACT WITH ADJUSTABLE STOP

(71) Applicant: SAFRAN ELECTRICAL & POWER, BLAGNAC CEDEX (FR)

(72) Inventors: Cecil BELTAN, BLAGNAC CEDEX (FR); Guillaume PRIEUR, BLAGNAC CEDEX (FR); Kévin ENOUF, BLAGNAC CEDEX (FR); Arnaud BADAULT, BLAGNAC CEDEX (FR)

(21) Appl. No.: 18/874,283

(22) PCT Filed: Jun. 12, 2023
(86) PCT No.: PCT/FR2023/050843

§ 371 Date: Dec. 12, 2024

(30) Foreign Application Priority Data
Jun. 13, 2022 (FR) FR2205693

(51) Int. Cl. H01H 3/16; H01H 1/26; H01H 3/32

(52) U.S. Cl. CPC H01H 3/163; H01H 1/26; H01H 3/166; H01H 3/32; H01H 2003/167; H01H 2003/323

(57) ABSTRACT

Economizing contact includes a fixed part, a part movable along a main direction, between a contact position and a break position, and an elastic blade attached to the fixed part forms an electric contact, as well as a stop mounted on the movable part and arranged for being away from the blade and coming to bear on the blade when the movable part is in contact position. The fixed part defines an orifice for passage of the stop facing the blade, where the orifice has an inner section substantially identical to an outer section of the stop, where the stop is movably mounted in translation in a plane on the movable part.

### FIELD OF THE INVENTION

The invention relates to the field of power-electronics switching components.

More specifically, the invention relates to an economizing contact for aircraft.

### DESCRIPTION OF RELATED ART

A contactor is a switching member four power electronics, comprising a movable part moved by a mechanical actuator for making and breaking an electronic circuit.

To limit the electrical consumption of the actuators in the contactors, one known solution is to use a contact called economizing, activating a coil called hold at the end of travel of the movable part of the contactor.

Such an economizing electrical contactor 1 is shown in FIG. 1, composed of a fixed part 2 and a movable part 3 which moves in translation in the direction Z between an upper electrical contact position and a lower position where the contact is broken.

The movable part 3 is urged towards the lower position thereof by one or more springs (not shown), in such a way that the movable part is in the lower position at rest.

The movable part 3 is driven in translation towards the upper position thereof by the action of an actuating coil when an actuating current passes through it, acting by induction on a core mounted on the movable part 3 and inserted between the turns of the actuating coil.

The translational movement of the movable part 3 serves to establish the electrical contact between an auxiliary blade 5 secured to the movable part 3 and an electrical board 6 secured to the fixed part 2.

The economizing electrical contact 1 further comprises at least one blade 8 mounted on the fixed part 2 bearing a contact pad 9 forming an economizing contact with a fixed contact, and at least one stop 10, mounted on the movable part 3 and arranged for interacting with the blade 8 during the travel of the movable part 3.

The economizing contact is closed at rest by the action of the blade 8 which urges the contact pad 9 towards the fixed contact, and opens when the stop 10 comes to bear against the blade 8 in upper position of the movable part 3.

The stop 10 is for example a pin projecting along the direction Z from the auxiliary blade 5 and passing by an orifice 11 opening in the electronic card 6 facing the blade 8.

Interaction between the blade 8 and the stop 10 serves to open the economizer contact and shift the operation of the electrical contactor by breaking the current in the actuation coil and by keeping the current in a holding coil, that consumes less energy.

The adjustment of the interaction between the blade 8 and the stop 10 is important in the sense where if the switch to the holding coil occurs too soon in the travel of the movable part 3, this part may not have power for reaching the end of travel and the economizing contact 1 may reopen under the restoring force.

If the interaction between the blade 8 and the stop 10 occurs too late, the separation distance of the economizing contact, between the pad 9 and the fixed contact, may be too short and cases of bouncing or even adhering may appear, impeding the proper operation of the economizer.

A cover is generally assembled around the assembly formed by the blade and the economizing contact, in order to protect it from the exterior.

Examples of economizing contacts are described in the documents CN208352212U, CN89211913U and CN211376540U.

However, a problem not considered by known economizing contact systems is that connected with the potential presence of dust near the economizing contact, despite said cover.

In fact, the orifice for passage of the stop in the electric board is much larger than the circumference of said stop, to accept large positioning tolerances of the economizing contact stop. The dimensions needed for this orifice allow the entry of dust into the closed space in the cover around the economizing contact, which may make the passage of current impossible. Thus, the command for closing the economizing contact, the current therefore passing in the two coils, call and hold, inhibits the economizing contact from closing.

### BRIEF SUMMARY OF THE INVENTION

The invention aims to remedy these disadvantages. For this purpose, the subject of the invention is an economizing electric contactor comprising a fixed part and a part movable in translation relative to the fixed part along a main direction, between a contact position of the electric contactor and a break position of the electric contactor, where the economizing electric contactor comprises an elastic blade attached to the fixed part by a first end and whose second end forms an economizing contact, as well as a stop mounted on the movable part and arranged for being away from the elastic blade when the movable part is in the break position thereof, where the economizing contact is then closed, and coming to bear on the elastic blade when the movable part is in contact position, the economizing contact then being open,
characterized in that the fixed part defines an orifice for passage of the stop facing the elastic blade along the main direction, where the orifice has an inner section transverse to the main direction substantially identical to an outer section of the stop, where the stop is movably mounted in translation in a plane perpendicular to the main direction on the movable part.

Such an electric contact serves to prevent the pollution of the economizing contact by dust while avoiding constraints related to tolerances of very small manufacturing dimensions.

The economizing contact can shift the actuating current from the contactor onto a holding coil when the movable part is at the end of travel and the economizing contact is closed.

Substantially identical is understood to mean that a contour of the section of the orifice follows a contour of the section of the stop with an offset forming a reduced play between the stop and the sides of the orifice, where the selected play is sufficiently small for blocking the passage of dust.

The play is for example less than or equal to 0.5 mm, in particular less than or equal to 0.3 mm.

The fixed part may comprise an electric board on which are mounted the blade, by a first end of the blade, and a fixed contact arranged near a second end of the blade, where the orifice is defined in the electric board, facing the blade.

With such a characteristic, the economizing contact can be held closed at rest and can be opened at the end of travel of the movable part.

The stop may comprise a foot comprising a flat part slidably mounted between a support and an auxiliary blade of the movable part.

With such a characteristic, a stop freely movable in the transverse plane is possible, for easily adjusting the position of the stop dynamically.

The support may comprise a recess receiving the flat part, where the auxiliary blade defines an orifice facing the recess, and where the stop extends through the opening towards the orifice for passage.

With such a characteristic, the stop can be robustly held in place while having a simple assembly and without impact on the arrangement of parts having small manufacturing tolerances.

The stop may comprise a threaded rod extending along the main direction and a head mounted on the rod and adjustable in height relative to the rod along the main direction.

With such a characteristic, the height of the stop can be adjusted and in that way the point of the travel of the movable part at which the economizing contact opens can be changed.

The stop may comprise a threaded ring engaged on the threaded rod and bearing the head.

With such a characteristic, the height of the head can be simply and precisely adjusted.

The ring may have a circular outer section having a first radius, where the orifice for passage has an inner circular section having a second radius, and where the first radius is less than the second radius for a play suited for impeding the passage of dust.

With such a characteristic, it is possible to have a good correspondence between the sections of the orifice and the stop, where the outer surface of the ring is simple to machine precisely.

The head may have a knob oriented towards the blade along the main direction.

Such a characteristic allows benefiting from a nearly point-like contact with the blade.

The knob may be rounded or pointed.

The head may be made of insulating material.

The insulating material is for example a polyamide-imide polymer.

With such a characteristic, the formation of parasitic currents in the stop can be prevented.

The stop may comprise means for locking the movement of the head relative to the rod.

With such a characteristic, the adjustment of the height of the head can be maintained once it is adjusted.

### BRIEF DESCRIPTION OF THE DRAWINGS

FIG. 1 is a schematic, sectional view of an economizing contact from the state-of-the-art;

FIG. 2 is a partial sectional view of an economizing contact according to the invention;

FIG. 3 is a sectional view in detail of a contact stop of the contact from FIG. 2; and

FIG. 4 is a transverse section view of an attachment of the stop from FIG. 3.

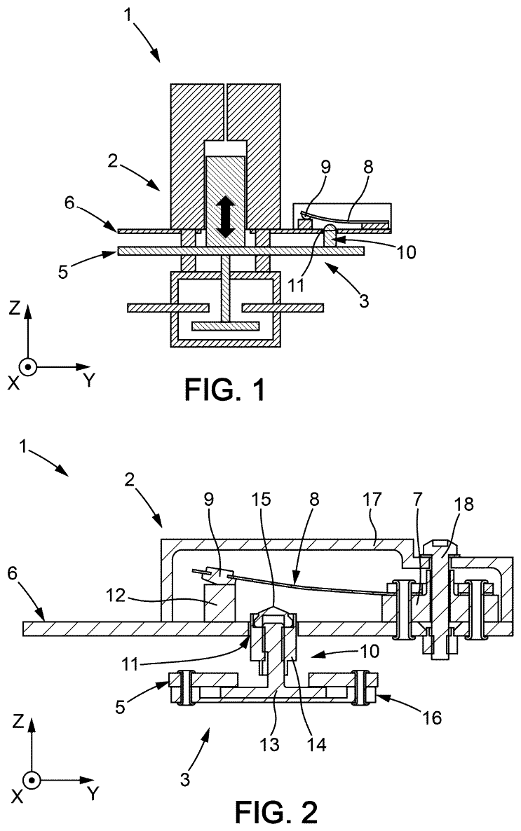

### DETAILED DESCRIPTION OF THE INVENTION

An economizing electrical contact 1 according to the invention is partially shown in FIG. 2. The electrical contactor comprises a fixed part 2 comprising an electrical board 6 and a movable part 3 comprising an auxiliary blade 5, as previously described.

The movable part 3 is movable in translation along a main direction Z under the action of an actuating coil (not shown in FIG. 2), so as to bring the electric board 6 and the auxiliary blade 5 closer.

The electric board 6 and the auxiliary blade 5 extend substantially parallel to each other, perpendicularly to the main direction Z.

The electric board 6 comprises a support 7 bearing an elastic blade 8, where said blade 8 is attached to the support 7 by a first end and bears a contact pad 9 at the free end thereof.

The contact pad 9 is urged by the blade 8 towards the fixed contact 12 secured to the electric board 6 so as to form an economizing contact closed at rest.

An orifice 11 is defined in the electronic board 6 facing the blade 8 along the main direction Z, where the orifice 11 has for example a substantially circular transverse section.

A stop 10 is coupled to the auxiliary blade 5 and extends projecting from the auxiliary blade 5 along the main direction Z, towards the blade 8.

The stop 10 is mounted movable relative to the auxiliary blade 5 according to a translational movement in the plane XY perpendicular to the main direction Z.

The stop 10 can in that way be positioned facing the orifice 11 in order to pass through said orifice 11 and to come to bear on the blade 8 during the travel of the mobile part 3.

The stop 10 comprises four distinct parts: a foot 13, a ring 14, ahead 15, and a support 16.

A cover 17 is attached to the electronic board 6 and surrounds the blade 8, the support 7 and the fixed contact 12, so as to confine and protect the economizing contact from the exterior.

The cover 17 is hermetically attached to the electronic board 6 to prevent the passage of dust, for example by means of a bolt 18.

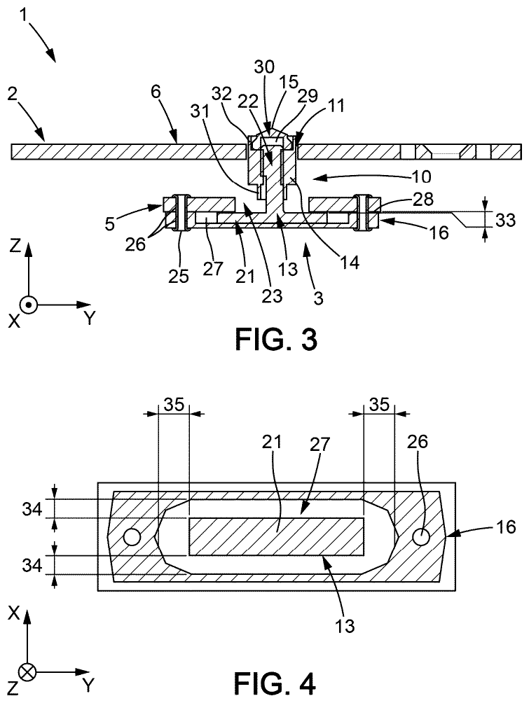

The stop 10 and the attachment thereof to the auxiliary blade 5 is shown in greater detail in FIGS. 3 and 4.

The foot 13 has a screw shape and comprises a flat portion 21 extending in the plane XY perpendicular to the main direction and a threaded rod 22 projecting from the flat portion 21 along a main direction Z towards the fixed part 2.

The auxiliary blade 5 defines a through opening 23 along the main direction Z, through which the rod 22 passes. The flat portion 21 is located on the side of the auxiliary blade 5 opposite the side where the electric board 6 is located.

The opening 23 has transverse dimensions, measured in a plane XY perpendicular to the main direction Z, less than transverse dimensions of the flat part 21, such that the flat part 21 has the transverse ends thereof bearing against the auxiliary blade 5 along the main direction Z. In other words, the flat part 21 is larger than the opening 23, transversely to the main direction Z, and therefore cannot pass through the opening 23.

The support 16 is a plate attached by crimping under the auxiliary blade 5, bearing along the main direction Z, for example by two attachment members 25 engaged in the corresponding attachment orifices 26 of the support 16 and of the auxiliary blade 5.

Alternatively, the support 16 can be attached to the auxiliary blade 5 by any other known means, for example by bolting, screwing, welding, etc.

A recess 27 that does not pass through is arranged in an upper surface 28 of the support, facing the auxiliary blade 5. The recess 27 has a depth, measured along the main direction Z, substantially constant over the full transverse extent thereof and slightly greater than a thickness of the flat portion 21 of the foot 13.

The flat portion 21 is arranged in the recess 27 and held along the main direction Z between the intermediate board 5 and the support 16.

The depth of the recess 27 is such that there is still play 33 between the auxiliary blade 5 and the flat portion 21, such that the flat portion 21 is mobile by sliding in the transverse plane XY between the auxiliary blade 5 and the support 16.

The play 33 for sliding is for example less than or equal to 0.5 mm, in particular less than or equal to 0.2 mm.

FIG. 4 shows, in section in the transverse plane XY, the flat portion 21 of the support and the recess. The flat portion 21 and the recess both have in this plane XY shapes elongated along the same transverse direction X, which is for example the direction of alignment of the attachment orifices 26 by crimping.

The flat part 21 is for example substantially rectangular in the transverse plane XY whereas the recess has a substantially oblong profile in the plane XY. The flat part 21 has a movement amplitude 34 along the first transverse direction X and a movement amplitude 35 along the second transverse direction Y, where these amplitudes are sufficient for the adjustment of the position of the stop 10.

The ring 14 has a general annular nut shape comprising an inner threading engaged on the threading of the rod 22, allowing adjusting the height of the ring 14 on said rod 22.

The height of the head 15, which is mounted on the ring 14, can be adjusted by modification of the height of the ring 14 on the rod 22, and in that way the moment of opening or closing the economizer contact in the travel of the mobile part 3 relative to the fixed part 2 can be modified.

The ring 14 has an outer section, transverse to the main direction Z, very close to an inner transverse section of the orifice 11 for passage of the stop 10. In that way, a very small residual play between the outer wall with the ring 14 and the inner walls of the orifice 11 during passage of the stop 10 through the orifice 11 impedes the passage of dust into the space defined by the cover 17 around the economizing contact.

The outer transverse section of the ring 14 is in particular circular.

The play between the outer walls of the ring and the inner walls of the orifice is for example less than 0.5 mm, in particular less than 0.3 mm.

To compensate for the very small positioning tolerances of the stop 10 due to this very small play, an adjustment of the position of the stop 10 opposite the orifice 11 is possible through translational movement thereof in the transverse plane XY.

The head 15 has a general crowned shape and defines a central recess 29 in which the upper end of the rod 22 is engaged at the summit 30 facing the blade 8.

It allows a nearly point-like contact between the stop 10 and the blade 8, which improves the repeatability of the opening and closing of the economizing contact during the displacement kinetics of the mobile part 3.

The head 15 also defines lateral edges with substantially cylindrical shape for keeping it in radial position by the ring 14.

The head 15 is advantageously implemented in an electrically insulating material, to avoid any parasitic current in the economizing contact.

The ring 14 advantageously has two deformable ends for the attachment by crimping of the ring to the rod and of the head to the ring respectively.

For example, the lower end 31 of the ring 14 comprises a thin cylindrical wall surrounding the rod 22 along an axis parallel to the main direction Z, irreversibly, radially deformable for coming to tighten on a lower part of the rod extending under the ring 14 so as to block the spiral movement of the ring on the rod on their respective threads. This allows guaranteeing the hold of the height of the ring 14 and the head 15 once this height is adjusted.

Advantageously, this lower part of the rod defines a flat area improving the attachment of the ring 14 by tightening.

Similarly, for example, the upper end 32 of the ring 14 comprises a second thin cylindrical wall radially surrounding the head 15 and whose upper edges extend beyond the lateral sides of said head 15. This second wall is irreversibly deformable around the lateral edges of the head 15 in order to lock said head 15 in position both axially along the main direction Z and radially.

1. An economizing electric contactor (1) comprising a fixed part (2) and a part (3) movable in translation relative to the fixed part (2) along a main direction (Z), between a contact position of the electric contactor and a break position of the electric contactor, where the economizing electric contactor (1) comprises an elastic blade (8) attached to the fixed part (2) by a first end and whose second end forms an economizing contact, as well as a stop (10) mounted on the movable part (3) and arranged for being away from the blade (8) when the movable part (3) is in the break position thereof, where the economizing contact is then closed, and coming to bear on the blade (8) when the movable part (3) is in contact position, the economizing contact then being open,
characterized in that the fixed part (2) defines an orifice (11) for passage of the stop (10) facing the blade (8) along the main direction (Z), where the orifice (11) has an inner section transverse to the main direction (Z) substantially identical to an outer section of the stop (10), where the stop (10) is movably mounted in translation in a plane (XY) perpendicular to the main direction (Z) on the movable part (3).

2. The economizing electric contactor (1) according to claim 1, wherein the fixed part (2) comprises an electric board (6) on which are mounted the blade (8), by a first end of the blade (8), and a fixed contact (12) arranged near a second end of the blade (8), where the orifice (11) is defined in the electric board (6), facing the blade (8).

3. The economizing electric contactor (1) according to claim 1, wherein the stop (10) comprises a foot (13) comprising a flat part (21) slidably mounted between a support (16) and an auxiliary blade (5) of the movable part (3).

4. The economizing electric contactor (1) according to claim 3, wherein the support (16) comprises a recess (27) receiving the flat part (21), where the auxiliary blade (5) defines an orifice (23) facing the recess (27), and where the stop (10) extends through the opening (23) towards the orifice (11) for passage.

5. The economizing electric contactor (1) according to claim 1, wherein the stop (10) comprises a threaded rod (22) extending along the main direction (Z) and a head (15) mounted on the rod (22) and adjustable in height relative to the rod (22) along the main direction (Z).

6. The economizing electric contactor (1) according to claim 5, wherein the stop (10) comprises a threaded ring (14) engaged on the threaded rod (22) and bearing the head (15).

7. The economizing electric contactor (1) according to claim 6, wherein the ring (14) has a circular outer section having a first radius, where the orifice (11) for passage has an inner circular section having a second radius, and where the first radius is less than the second radius for a play suited for impeding the passage of dust.

8. The economizing electric contactor (1) according to claim 5, wherein the head (15) has a summit (30) oriented towards the blade (8) along the main direction (Z).

9. The economizing electric contactor (1) according to claim 5, wherein the head (15) is made of insulating material.

10. The economizing electric contactor (1) according to claim 5, wherein the stop (10) comprises means for locking (31, 32) the movement of the head (15) relative to the rod (22).
